(19) United States
(12) Patent Application Publication
(10) Pub. No.: US 2009/0052582 A1
(43) Pub. Date: Feb. 26, 2009

(54) Method for improving the performance of ofdm receiver and a receiver using the method

(76) Inventor: Roy Oren, Magshimim (IL)

Correspondence Address: EMPK & Shiloh, LLP;c/o Landon IP, Inc., 1700 Diagonal Road, Suite 450, Alexandria, VA, 22314, US

(21) Appl. No.: 11/887,109

(22) PCT Filed: Mar. 30, 2006
(86) PCT No.: PCT/IL2006/000395

§ 371 Date: Oct. 27, 2008

Related U.S. Application Data
(60) Provisional application No. 60/668,581, filed on Apr. 6, 2005.

(51) Int. Cl. H04L 25/06; H04L 27/06

(52) U.S. Cl. 375/319; 375/316

(57) ABSTRACT

One or more parameters of a tuner of a receiver may be adjusted by generating for the receiver one or more control signals associated with one or more parameters and applying control signals to the tuner during a cyclic prefix (CP) period. The receiver may generate a control strobe in synchronization with the CP period wherein the control strobe essentially begins with the CP period and has duration preferably shorter than the duration of the CP period. The duration of the control strobe may be chosen such that the one or more control signals, after being applied to the tuner, each reaches its steady state before the CP period lapses. The adjusted parameters, alone or in combination, may be, for example, the gain of the low-noise-amplifier (LNA), the synthesizer's local frequency, the DC correction level, the power gain amplifier, and the I/Q error, and the like. The demodulator of the receiver may generate one or more of the control signals required for adjusting one or more parameters. One or more control signals may be determined according to previously received symbols/transmissions, and by determining the tuner's parameters to be adjusted based on the receiver's continued performance evaluations, and generating and applying the control signals to the tuner as a consequence of or in relation to these evaluations.

### FIELD OF THE DISCLOSURE

The present disclosure relates generally to the field of orthogonal frequency division multiplexing (“OFDM”) modems. More specifically, the present disclosure relates to a method for improving the performance of an OFDM-enabled receiver, and to an OFDM-enabled receiver that utilizes the method.

### BACKGROUND

The capacity of digital multimedia applications/services rendered is growing rapidly, side by side with communication standards that are being continuously formulated to adapt services to handheld and in other generally mobile and/or wireless service(s) rendering devices. One result of this trend is increasing demand for broadband telecommunication systems.

OFDM is an advanced communication method that allows transmitting high data rates over extremely hostile channels (for example noisy and echoic channels), by using a relatively low complex transmitter and receiver. OFDM has been chosen as the transmission standard for the European radio digital audio broadcasting (“DAB”) and terrestrial digital video broadcast terrestrial (“DVB-T”) standards. The OFDM methodology is variously described in many articles. For example, it is described in “Basic of Orthogonal Frequency Division Multiplexing (OFDM)” (from Greg DesBrisay, © 2000 Cisco Systems, Inc.) and in “Orthogonal frequency-division multiplexing” (by wikipedia, website: en.wikipedia.org/wiki/Orthogonal_frequency-division_multiplexing).

In general, DAB is a technology for broadcasting audio programming in digital form that was designed in the late 1980s. The original objectives of converting from analog to digital systems were to enable higher fidelity, greater noise immunity, mobile services, and new services. Digital audio broadcasting has been introduced in many countries. Whilst DAB offers many potential benefits, its introduction has been hindered by a lack of global agreement on standards. DAB is based on OFDM for transmitting digital data over a radio channel. A typical DAB-based system may include audio codec, modulation and error correction coding schemes. OFDM is currently used much more than DVB-T and DAB, as it is used with WiMax, wireless local area network (W-LAN), Digital Subscriber Line (“DSL”), cellular telephony and other types of systems.

WiMax (Worldwide Interoperability for Microwave Access) is a standards-based wireless technology that provides high-throughput broadband connections over long distances. WiMAX can be used for a number of applications, including “last mile” broadband connections and cellular backhaul, and high-speed enterprise connectivity for business. WiMAX enabled products are capable of forming wireless connections between them to permit the carrying of Internet packet data. WiMAX is similar to WiFi in concept, but has certain improvements that are aimed at improving performance and extending communication distances.

DSL is, in general, a family of technologies that provide digital data transmission over the wires used in the “last mile” of a local telephone network. Typically, the download speed of DSL ranges from 128 kilobits per second (Kbps) to 24,000 Kbps depending on DSL technology and service level implemented. Upload speed is lower than download speed for asynchronous DSL (“ADSL”) and symmetrical for synchronous DSL (“SDSL”).

More specifically, an OFDM baseband signal is the sum of a number of orthogonal sub-carriers, with data on each sub-carrier being independently modulated, commonly by using some type of quadrature amplitude modulation (“QAM”) or phase-shift keying (“PSK”). This composite baseband signal is typically used to modulate a main radio frequency (“RF”) carrier. The data (in the form of symbols) rate to be conveyed by each of these sub-carriers is correspondingly reduced, meaning that the symbol length is in turn time-wise extended. These modulation symbols on each of the sub-carriers are arranged to occur simultaneously.

In digital communications, data is transmitted in the form of symbols where each symbol represents a certain combination of binary digits. Symbols rate (measured in symbols-per-second) is the bit rate divided by the number of bits transmitted in, or associated with, each symbol. The symbol rate is particularly relevant to digital modulation schemes where the number of symbols allowed in a modulation scheme is a key factor in determining how many bits-per-second the communications system can transmit and, in generally, handle.

QAM (quadrature amplitude modulation) is a modulation scheme that conveys data by changing (modulating) the amplitude of two carrier waves. These two waves, usually sinusoids, are out of phase with each other by 90° and are thus called quadrature carriers. In QAM, the two carrier waves are combined to form a single channel, thereby doubling the effective bandwidth. QAM is used with pulse amplitude modulation (PAM) in digital systems, especially in wireless applications. One of the two carrier waves is called the I signal (the in-phase wave), and the other is called the Q signal (the out-of-phase wave). Mathematically, one of the signals can be represented by a sine wave, and the other by a cosine wave. The two modulated carriers are combined at the source (transmitter) for transmission. At the destination (receiver), the two carrier waves are separated, the data is extracted from each carrier wave and then the data is combined to obtain the original modulating information.

PSK is a method of digital communication in which the phase of a transmitted signal is varied to convey information. There are several methods that can be used to accomplish PSK. The simplest PSK technique is called binary phase-shift keying (BPSK), and it uses two opposite signal phases (0 and 180 degrees). The digital signal is broken up time-wise into individual bits (binary digits). The state of each bit is determined according to the state of the preceding bit. If the phase of the wave does not change, then the signal state stays the same (0 or 1). If the phase of the wave changes by 180 degrees; that is, if the phase reverses, then the signal state changes (from 0 to 1, or from 1 to 0).

More sophisticated forms of PSK exist. In multiple phase-shift keying (MPSK), there are more than two phases, usually four (0, +90, −90, and 180 degrees) or eight (0, +45, −45, +90, −90, +135, −135, and 180 degrees). If there are four phases (m=4), the MPSK mode is called quadrature phase-shift keying or quaternary phase-shift keying (QPSK), and each phase shift represents two signal elements. If there are eight phases (m≦8), the MPSK mode is known as octal phase-shift keying (OPSK), and each phase shift represents three signal elements. In MPSK, data can be transmitted at a faster rate, relative to the number of phase changes per unit time, than is the case in BPSK.

The sub-carriers usually have common, precisely chosen, frequency spacing. This is the inverse of the duration called the “active symbol period”, during which period a receiver extracts and examines the data or information (referred to herein interchangeably) contained within the signal. In many cases where a signal simultaneously conveys different data elements, a filter has to be used by the receiver for discriminating between the different data elements. However, The way the sub-carriers are spaced (in OFDM) ensures the orthogonality of the sub-carriers, which means that the demodulator for one sub-carrier does not recognize, or is not affected by, the modulation of the other subcarriers, so there is no effective crosstalk between sub-carriers even though there is no explicit filtering even though their spectra overlap. In telecommunication the term “crosstalk refers to a phenomenon by which a signal transmitted on one circuit or channel of a transmission system creates an undesired effect in another circuit or channel.

A phenomenon, known in the art as “multipath delay” causes information symbols to overlap at the receiver. Multipath delay refers to a situation where a given symbol is received at a receiver via different physical paths, which results in receiving the symbol, replicas thereof and maybe other different symbols, after different delays. Depending on the severity and nature of the multipath delay interference, successively transmitted symbols, may reach a receiver at substantially the same time. This phenomenon, or type of interference, which causes different symbols to overlap, at least partially, at the receiver, is often referred to as intersymbol interference (“ISI”). ISI is, therefore, a type of communication interference where different symbols overlap, fully or partially, at the receiver. In some cases (depending on the communication path between the transmitter and the receiver), ISI may result in constructive and/or destructive interferences, which may result in the cancellation or fading of the received signal, which is a problematic phenomenon because the receiver, under extreme conditions, may not be able to correctly interpret the received symbols. Constructive and destructive interference refer to a situation where two or more waves are superimposed on one another. When two waves are superimposed on one another, the resulting waveform depends on the frequency (or wavelength), amplitude and relative phase of the two waves. If the two waves have the same amplitude (A) and wavelength, the resultant waveform will have amplitude between 0 (in cases of destructive interference) and 2 A (in cases of construction interference), depending on whether the two waves are in phase or out of phase. In addition, multipath may cause symbols and delayed replicas of symbols to arrive at the receiver with some delay spread (that is, with different delays), leading to misalignment between sinusoids that need to be aligned in order to maintain the sub-carriers orthogonal.

To reduce the effect of ISI, a guard interval is traditionally added, or appended, to each active symbol in a way that each symbol is transmitted for a total symbol period that is longer than the active symbol period by a period called the guard interval or cyclic prefix, referred to herein interchangeably. A combination of an active symbol and the cyclic prefix appended to it is referred to herein as an extended symbol. The traditional purpose of the guard interval is to introduce immunity to echoes and reflections while using OFDM coding since digital data is normally very sensitive to echoes and reflections. As long as the echoes fall within the guard interval they will not affect the receivers ability to safely decode the actual data, as data is only interpreted outside the guard interval. The longer the guard interval the more distant echoes can be tolerated. However, the longer the guard interval is relative to the useful data transmission the more data capacity per time unit is lost. The cyclic prefix (CP) is a copy of the last portion of the data symbol appended to the front of the symbol during the guard interval. CPs ensure that delayed data replicas will include same information as non-delayed data. In addition, CPs facilitate realigning of data portions at the receiver and, thus, regaining orthogonality.

The cyclic prefix is sized appropriately to serve as a guard time to eliminate ISI. This is accomplished because the amount of time dispersion from the channel is smaller than the duration of the cyclic prefix. A fundamental trade-off is that the cyclic prefix must be long enough to account for the anticipated multipath delay spread experienced by the system. The amount of overhead increases, as the cyclic prefix gets longer. The sizing of the cyclic prefix forces a tradeoff between the amount of delay spread that is acceptable and the amount of Doppler shift that is acceptable.

A receiver receiving symbols (with their respective guard interval) removes the signal contained within each guard interval as being problematic, and only processes the signal contained within the respective active symbols. This way, the receiver will not experience, or factor-in, (the receiver will ignore or discard) signal portions that are suspected as including ISI and possibly other types of interferences, provided that any echoic signals present in the signal have a delay which resides within the guard interval. By “echoic signal” is meant a signal(s) previously transmitted but currently received, due to delay, with a signal that was transmitted later. The guard interval reduces the data capacity by an amount that depends on its temporal length. For example, in the DVB-T standard, a guard interval is used which is not greater than ¼ of the active symbol period, but can protect against echo delays of the order of 200 microseconds (μs) (depending on the mode chosen).

The benefits of using OFDM are many, including high spectrum efficiency, substantial resistance against multipath interference, and ease of filtering out noise. If a particular range of frequencies suffers from interference, the sub-carriers within that range can be disabled or made to run slower.

Despite its advantages, OFDM tends to suffer from time-variations in the channel, or presence of a sub-carrier frequency offset (due to imperfect frequency synchronization). This phenomena may cause loss in sub-carriers orthogonality, which may result in energy “leakage” between OFDM sub-carriers and, therefore, in degradation in the performance of the receiver. This type of interference (energy leakage from one OFDM sub-carrier to another is often referred to as inter-carrier interference (“ICI”).

In order to maintain high communication performance, it is essential that the receiver should accommodate varying communication conditions. For enabling such accommodation, it is essential, for example, that parameters of the receiver should change according to actual communications conditions. Because several types of communication interferences (for example multipath interference, ISI and ICI) may occur during communication, it would have been beneficial to have a receiver in which a number and types of parameters could be adjusted to accommodate for interferences.

Traditionally, OFDB-based tuners are adjusted during the reception of data or information. This course of action has several drawbacks. For example, changing a tuner's parameter(s) (for example gains and DC offsets) during data reception usually detrimentally affects the integrity of the received data because a OFDM receiver is sensitive to varying reception conditions over time, and significant variations of that kind during active symbols' period are common. Therefore, adjusting (setting parameters of) a receiver during active symbol periods, during which time reception conditions constantly change, often results in undesired abrupt, or otherwise undesired, changes in the demodulated signal, which degrade signal decoding (data or information extraction and reconstruction) by the receiver. In addition, once new parameters values are determined for a receiver, it takes time to substitute current parameters values with the newly determined parameters values; that is, it takes time before the new values reach their steady state values, during which (transition) time data/information contained within the active symbol still has to be processed.

Therefore, a need exists for adjusting (the control parameters of) a tuner during the guard interval, during which time no data or information is transmitted. In particular, a need exists for allowing recently adjusted parameters (in an OFDM-enabled receiver) to reach their steady state before receiving data or information during a following active symbol.

### SUMMARY

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other advantages or improvements.

As part of the present disclosure, a method is disclosed for adjusting one or more parameters of a receiver. The method may comprise generating, one or more control signals that are associated with the one or more parameters to be adjusted, and applying the generated one or more control signals to selected elements or units within the receiver to adjust its operation. The one or more control signals may be generated within the receiver, such as by the demodulator, or externally, by any suitable circuit or element that is adapted or designed to temporally distinguish cyclic prefix (CP) periods from the respective active symbols.

According to some embodiments of the present disclosure a control strobe may be generated, such as by the receiver (or externally), in synchronization with the cyclic prefix (CP) period wherein the control strobe essentially begins with the CP period and has a duration shorter than the duration of the CP period. The control strobe may indicate to the circuit element or unit that generates the one or more control signals (for example to the receiver's demodulator) that it is time to apply the one or more control signals to the circuit element or unit requiring them.

According to some embodiments of the present disclosure the duration of the control strobe may be chosen such that applying the one or more control signals to the circuit element or unit requiring them will result in the respective parameters reaching their steady state during the following cyclic prefix (CP) period.

According to some embodiments of the present disclosure the parameters to be adjusted by corresponding control signals may be selected from a group of parameters consisting of: {The gain G_{LNA} of the low-noise-amplifier (“LNA”); The synthesizer's local frequency F_{LO}; The DC correction level L_{DC}; The power gain amplifier G_{PGA}; Mixer gain G_{MIX}, I/Q imbalance (or I/Q error) correction}.

According to some embodiments of the present disclosure the demodulator of the receiver may generate the one or more of the control signals. In general, the one or more control signals may be generated by any circuit element or unit that is adapted, or configured or designed, to identify the boundaries of symbols' periods, though normally this task is intended for the demodulator.

In some embodiments of the present disclosure, the one or more of the control signals may be determined according to previously received symbols. More specifically, parameters may be adjusted at the receiver based on the receiver's continued performance evaluations, and corresponding control signals may be generated and applied to the receiver as a result of these evaluations.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. It is intended that the embodiments and figures disclosed herein be considered illustrative, rather than restrictive. The disclosure, however, both as to organization and method of operation, together with objects, features, and advantages thereof, may best be understood by reference to the following detailed description when read with the accompanying figures, in which:

FIG. 1 (prior art) shows a simplified block diagram of a digital radio receiver;

FIG. 2 (prior art) shows a simplified typical block diagram of a tuner such as the tuner of the receiver of FIG. 1;

FIGS. 3a and 3b (prior art) show graphical representations denoting appending a cyclic prefix to an active symbol;

FIG. 4 (prior art) show graphical representation denoting cyclic prefix removal;

FIG. 5 shows a graphical representation denoting tuner control strobe and signal timing according to some embodiments of the present disclosure;

FIG. 6 schematically illustrates an exemplary receiving system according to some embodiments of the present disclosure; and

FIG. 7 shows an exemplary simplified block diagram of a method for adjusting a receiver according to some embodiments of the present disclosure.

It will be appreciated that for simplicity and clarity of illustration, elements shown in the Figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that throughout the specification discussions utilizing terms such as “processing”, “computing”, “calculating”, “determining”, “deciding”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The disclosure, its embodiments and its novel features, as well as items or according to the teachings, may take the form of an entirely hardware embodiment, an entirely software embodiment or an embodiment containing both hardware and software elements. In one embodiment, the disclosure is implemented in software, which includes but is not limited to firmware, resident software or microcode.

Embodiments of the present disclosure may include an apparatus for performing the operations described herein. This apparatus may be specially constructed for the desired purposes, or it may comprise a general-purpose computer or processor selectively activated or reconfigured by a computer program stored in the computer.

The processes presented herein are not inherently related to any particular computer or other apparatus. Various general-purpose systems may be used with programs in accordance with the teachings herein, or it may prove convenient to construct a more specialized apparatus to perform the desired method(s) or develop the desired system(s). The desired structure(s) for a variety of these systems will appear from the description below. In addition, embodiments of the present disclosure are not described with reference to any particular receiver. It will be appreciated that a variety of receivers may be used to implement the teachings of the disclosures as described herein.

Normally, the impulse response of a receiver, between a tuner's output and the output of a fast Fourier transform (“FFT”) engine employed by its demodulator is time-wise shorter than the guard interval period. That is, the period of the guard intervals is chosen such that transient effects do not exceed that period, for allowing the receiver to remove the problematic signal portion during, or within, each guard interval, and process only the signal during, or within, the respective active symbols. Consequently, substantially any transient signal intervening with the received data for a fraction of time during, or within, the guard interval, will have no detrimental effect on the resulting decoded data. Therefore, transitions involved in generating and applying control signals to the receiver for changing one or more of the receiver's parameters, may have an undesired effect only during the guard interval and will not ill affect the demodulator and, therefore, the decoded data, as the functionality of the receiver, and in particular the functionality of demodulator and data decoder circuitry, will reach steady state substantially before the data or information is extracted.

Referring now to FIG. 1, a high-level block diagram of a digital radio receiver (designated at 100) is schematically illustrates. A typical wireless digital receiver 100 may be consisted of a wireless receiver, such as Wireless receiver 120, and a host processor such as Host processor 104. Wireless receiver 120 may consist of one or more tuners such as tuner 101 and analog to digital converter (“ADC”) and Demodulator 102, which may serve as a base-band unit. Traditionally, tuner 101 receives one or more RF signal(s), shown at 103, via RF antenna 110. Normally, tuner 101 is tuned to receive a specific RF signal and it converts the received signal into a signal whose radio frequency (“RF”) carrier frequency is small enough so it can be conveniently sampled and digitally processed by a digital demodulator 102. More specifically, tuner 100 adjusts its local frequency (not shown) according to the frequency of the received signal, to forward (shown at 111) to ADC and Demodulator 102 an intermediate frequency (“IF”) signal. ADC and Demodulator 102 demodulates the IF signal to extract the data or information. Then, the demodulated data may be forwarded (shown at 112) to a destination (source decoder, data processor, or the like, generally denoted herein as a “host processor” 104). One or more host processors such as Host processor(s) 104 may be part of a wireless digital receiver 100.

Typically, each module in the wireless digital receiver 100 is controlled by a respective control signal (shown at 105 and 106), that is generated by the following module. This way, the performance of receiver 100 is improved by having the data or signal, which is forwarded from one module to another (shown at 111 and 112), adjusted to the needs, or requirements, of the module receiving the data or signal. For example, host processor 104 may control (105) demodulator 102 to get from it signals in the form that suit host processor 104 requirements. Likewise, demodulator 102 may control (106) tuner 101 to get from it signals in the form that suit demodulator 102 requirements.

One effective common architecture for low cost and low power tuner design is known as Zero Intermediate Frequency (“ZIF”) converter, which is also known as a “direct conversion tuner”. According to this architecture, the RF signal is converted using a single conversion step, in which the RF carrier frequency is converted into a substantially zero frequency. More about ZIF may be found in “Tutorial on Designing Delta-Sigma Modulators: Part 1” by Mingliang Liu of Extron Electronics (Mar. 30, 2004).

Many advanced receivers employ “low-IF” or “zero-IF” (ZIF) techniques whereby the IF frequency is very low, or even zero. In these types of tuners, the input RF carrier signal is converted directly to a base-band signal using a single conversion. The tuner usually has several degrees of freedom (“DOF”) (such as controllable gains that can be manipulated, for optimizing the receiver's performance, by adjusting corresponding control parameters of the receiver.

The advantage of ZIF based tuners is that there is usually no need for an additional mixing stage to convert the IF signal to a base band signal. Instead, the IF signal can be applied directly, as is, to an analog-to-digital converter (“ADC”). Another advantage is that usually there is no need for band pass filtering of the RF signal (for example of the signal at the mixer's input). ZIF based tuners typically utilize low pass filter (“LPF”) prior th the ADC for performing anti-aliasing. The LPF would typically be designed to substantially attenuate frequencies which are higher then twice the sampling rate of the ADC minus the highest frequency in the band of interest.

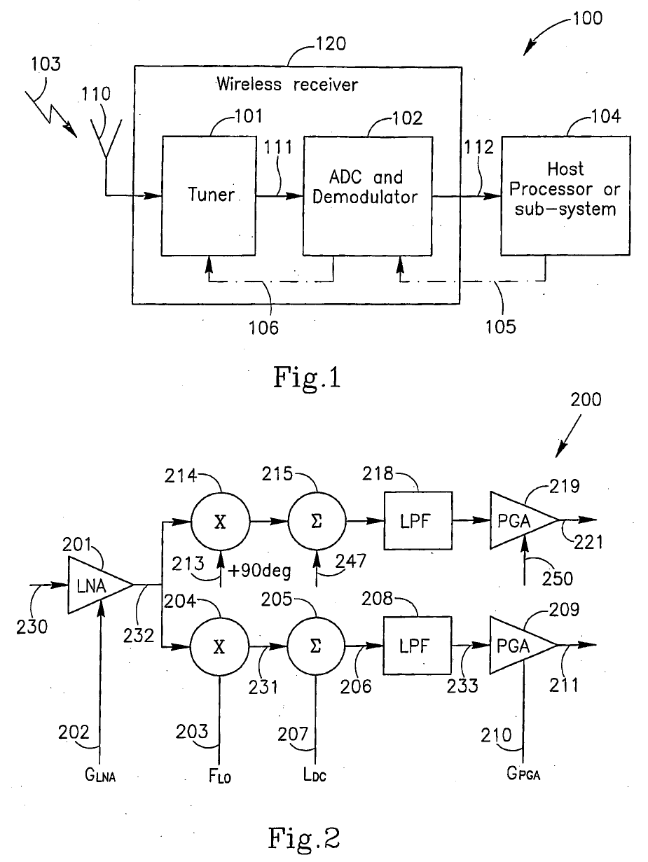

Referring now to FIG. 2 (prior art), a high-level block diagram of a digital wireless receiver is schematically illustrated. Tuner 200, which is substantially similar to tuner 101 of FIG. 1, is a ZIF based tuner. Because an OFDM signal is the sum of orthogonal sub-carriers, as explained hereinbefore, tuner 200 is shown having two demodulation (process) paths, “path I” (“I” standing for in-phase) and “path Q” (“Q” standing for quadrature). Path Q is 90 degrees shifted relative to the I path. Path I is shown including (signal) mixer 204, DC correction circuitry 205, LPF 208 and programmable gain amplifier (“PGA”) 209. Path Q is shown including (signal) mixer 214, DC correction circuitry 215, LPF 218 and PGA 219. To comply with the OFDM standards, the local oscillator synthesizer (not shown) that is coupled to mixer 214 forwards to mixer 214 a signal (shown at 213) whose frequency is substantially identical to the frequency of the signal forwarded (shown at 203) to mixer 204, though signal 213 is shifted (relative to signal 203) by +90 degrees. The I and Q paths are fed by the same signal, which is the signal output from Low noise amplifier (“LNA”) 201, and their output signals (shown at 211 and 221, respectively) are added and further processed (not shown) to obtain the data or information.

The gain parameter of LNA 201 is controllable (adjustable) by control signal G_{LNA} (202) for allowing compensating for loss (undesired attenuations) in the level of input signal 230 across the entire band used by the receiver using tuner 200. This type of loss may result from antenna imperfections, for example. The dynamic range of control signal G_{LNA} 202 is usually limited by other signals in the band used. Another adjustable parameter, by which the operation of tuner 200 may be optimized, is the frequency of the local synthesizer that feeds mixer 204. Accordingly, the synthesizer local frequency F_{LO} (203) may be also utilized as a control signal for selecting the required channel (channel of interest) and also for compensating for intermediate frequency (IF, shown at 231) undesired changes and drifts. Mixer 204 mixes the output signal of the LNA 201 (shown at 232) with the local signal F_{LO} (203) to generate the IF signal (, shown at 231). Another adjustable parameter is the input DC correction signal of DC correction circuitry 205. Accordingly, a control signal called DC correction voltage L_{DC} (207) may be used, which is subtracted (at DC correction circuitry 205) from the received IF signal 231 in order to compensate for undesired DC offset voltages.

Undesired DC offset voltages may occur because of different reasons, for example, because of a poor low FLO-to-RF isolation. LO-to-RF isolation refers to the isolation between the synthesizer local frequency F_{LO} (203) signal and the RF circuitry of the tuner. Poor low FLO-to-RF isolation refers to a situation where some of the F_{LO} signal undesirably leaks and received, at least partly, at the receiver (whether via its RF antenna or not), and then mixed with the F_{LO} signal. Poor low FLO-to-RF isolation results in time-varying dc offset that is introduced at the mixer output due to the self-mixing of the original and leaked local oscillator (LO) signals. The problem of undesired DC offset caused by self-mixing due to LO leakage is addressed by some articles, for example, by “A 900 MHz CMOS Balanced Harmonic Mixer for Direct Conversion Receivers” by Zhaofeng Zhang et al. (Department of Electrical & Electronic Engineering, Hong Kong University of Science & Technology). More specifically, mixing the F_{LO} signal (203) and the leaking signal, both of which are sinusoidal signals, undesirably creates a noticeable and detrimental DC component, as demonstrated by expression (1):

A*sin(t)*sin(t+φ)=A*sin(2*t+φ)+A*cos(φ) (1)

where A is constant, sin(t) is the FLO signal, sin(t+φ) is a portion of sin(t) that leaked to the air and received and mixed by a mixer, such as mixer 204 of FIG. 2, with sin(t), φ is the phase shift of the leaking signal sin(t+φ) relative to the original FLO signal (sin(t)) and A*cos(φ) is the DC voltage resulting from that phase shift. Since φ is random, so is A*cos(φ); that is, the DC offset derived from it.

DC offset voltages may be created also by a phenomenon called “one over f”. “One over f” is a phenomenon in a complementary metal-oxide-semiconductor (CMOS) technology, according to which DC voltages are created in the CMOS transistors. 1/f noise (“one-over-f noise”, occasionally called “flicker noise” or “pink noise”) is a type of noise whose power spectra P(f) as a function of the frequency f behaves like: P(f)=1/f^{a}, where the exponent a is very close to 1 (which is where the name “1/f noise” comes from). LPF 208, which is the first LPF in the I path, filters out unwanted signals to prevent aliasing in the following analog-to-digital converter (not shown). Another parameter that can be adjusted to optimize the operation of tuner 200 is the gain of PGA 209. Accordingly, a control signal called G_{PGA} (210) may be used for adjusting the gain of PGA 209, for compensating for the loss of the specific channel (the channel of interest) and other losses in tuner 200. Control signal G_{PGA} (210) also adjusts the signal's dynamic range to prevent the following ADC (not shown) from saturating. The term “loss of the specific channel” refers to a situation where G_{LNA} 202 (for example) is set to output a signal (shown at 232) with a total power at a desired, or prescribed, level, but the channel of interest (among the sub-carriers) is relatively significantly attenuated relative to other channels (sub-carriers). By “total power” is meant the sum of the power of the entire signal at the mixer's input. Therefore, if most of the power lies in the neighboring channels (sub-carriers other than the desired channel, or sub-carrier), than these neighboring channels will be filtered out by the LPF. In order to compensate for the filtered out (or “too filtered”) neighboring channels, an additional compensating gain should be introduced at the LPF output (shown at 233), for amplifying the too filtered out sub-carriers, whether they are neighboring channels or other channels. The additional, compensating, gain may be implemented using PGA 209, by applying a corresponding control signal G_{PGA} 210.

Channel selectivity is generally performed by first setting the frequency of the local synthesizer (F_{LO}, 203) to a frequency such that the mixing of the LNA (201) output signal (232) with F_{LO} (203) will provide the required, or set, IF signal (F_{IF} 231 and 206). In order to process signal 211, it is required to convert signal 211 to a digital signal. Therefore, tuner 200 further includes, or uses, an ADC module which is not shown in FIG. 2.

If not handled properly, the ADC (not shown) will introduce aliasing into the processed signal (231) in respect of every signal whose frequency is higher than the sampling rate used. In order to prevent aliasing, all the signals whose frequency is higher than twice the sampling frequency minus the highest frequency in the band of interest are filtered out (such as by using low-pass-filter 208) before reaching the ADC.

The functionality of various modules and elements, including adjustable parameters and control signals, were primarily described hereinbefore in connection with the I path. However, as may be appreciated by a person with skill in the art, the functionality and control considerations concerning the Q path are substantially similar to those of the I path. For example, Mixer 214 functions insubstantially in the same manner as mixer 204. Likewise, DC Correction module 215, LPF 218 and PGA 219 function substantially in the same manner as DC Correction module 205, LPF 208 and PGA 209, respectively. Therefore, the overall operation of tuner 200 may be optimized by controlling only the operation of the I path, or only the operation of the Q path, or controlling the operation of both the I and Q paths, by adjusting one or parameters in the I path, or in the Q path, or in both I and Q paths, by applying corresponding respective control signals.

Regarding the Q path, the operation of mixer 214, DC Correction module 215 and PGA 219 may be adjusted by applying the control signals F_{LO} 213, L_{DC} 247 and G_{PGA} 250, respectively. Several control parameters may be adjusted to maintain high-quality reception performance, substantially at any given moment, by adjusting one or more control parameters to cause a wireless receiver such as Wireless receiver 120 to output an optimized signal (211, for example). The high-quality reception performance may be obtained if the one or more control signals, which may be devised by constant, or intermittent, evaluation of the received signals, are applied to the corresponding module(s) or element(s) (for example applying G_{LNA} 202 to LNA 201) between the reception of two successive symbols (during some portion of the respective guard intervals), as is described in connection with FIG. 5, for example. As may be appreciated by one of skill in the art, other parameters may be utilized, alone or in combination with any one of the parameters specified herein before, for optimizing the operation of the receiver.

Referring again to FIG. 1, control signals for tuner 101 (shown at 106) are typically set by demodulator 102 based on the received signal and signals' monitored levels. After being set, the control signals can be sent (shown at 106) to tuner 101 either digitally (after which they are converted to analog internally, at tuner 101) or analogically.

The bandwidth, or nature, of the control signals has to be such that the control signals do not cause aliasing noise and other types of noises once they are applied to the corresponding circuit element or units. Aliasing noise is avoided by passing the control signals through a corresponding low pass filter (not shown).

In OFDM signals, as is explained earlier, a guard interval is inserted in the time domain as a preamble of the active symbol in order to mitigate the problem of delay spread. The data transmitted during the guard interval period is the cyclic prefix of the symbol. In the receiver, the signal content received during the guard interval is ignored (in the time domain), though it may be used by the receiver for reception quality evaluation, and signal that is received during the active symbol period is processed by the receiver and transformed to the frequency domain in order to extract the data or information.

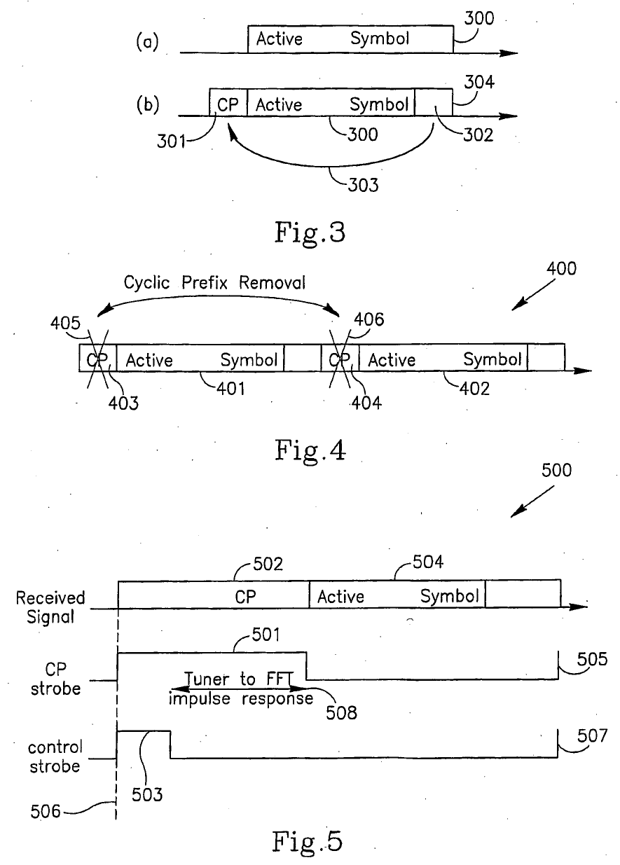

Referring now to FIGS. 3a and 3b (prior art), a graphical representation is shown denoting appending a cyclic prefix to an active symbol. FIGS. 3a and 3b show an active symbol before and after the cyclic prefix insertion, respectively. For a OFDM-enabled transmitter to transmit data or information, the OFDM transmitter typically generates, and thereafter transmits, a stream of active symbols like active symbol 300 of FIG. 3a, which contain, or carry, data or information. As explained hereinbefore, the OFDM transmitter separates between successive symbols by appending a cyclic prefix (CP) to each symbol before it transmits the active symbol (with the appended CP. As is explained hereinbefore, the cyclic prefix is a copy of the last (trailing) portion of the data or information symbol appended to the front (leading edge) of the symbol. For example, CP 301, which is a copy (symbolically shows as 303) of the trailing portion 302 of exemplary active symbol 300, is shown (in FIG. 3b) appended to the leading edge of active symbol 300. Extended symbol 304 consists of active symbol 300 and the CP 301 appended to it.

Referring now to FIG. 4, traditional removal of cyclic prefixes from an exemplary stream of symbols is graphically shown. An OFDM-enabled tuner, such as tuner 101, traditionally receives streaming symbols such as symbol stream 400, and removes the CPs, as exemplified in FIG. 4. Exemplary symbol stream 400 is shown consisting of symbols 401 and 402, with their cyclic prefixes (403 and 404, respectively), as transmitted by a OFDM-enabled transmitter. At the OFDM-enabled receiver, cyclic prefixes 403 and 404 are detected or identified, and thereafter removed (symbolically shown as 404 and 406), or simply discarded or ignored by the receiver.

Referring now to FIG. 5, it shows the generation of a control strobe according to some embodiments of the present disclosure. According to some embodiments of the present disclosure, before the OFDM-enabled receiver discards of (removes) the cyclic prefix 502 of a currently received extended symbol 500 (for extracting, or isolating, the active symbol 504), the receiver may utilize CP 502, and other CPs (not shown), to generate a CP strobe signal 505 that is fully in synchronization with the CPs of the received signal. Exemplary CP strobe signal 505 is shown corresponding to extended symbol 500, for it is shown consisting of one CP strobe (shown at 501) which is in full synchronization with the timing and duration of CP 502. Then, the receiver may generate a tuner control strobe (shown at 503), during which time one or more of the tuner's parameters may be adjusted, or set, by applying corresponding control signals to corresponding receiver's modules or elements, for optimizing the receiver performance. In some embodiments, the duration of control strobe 503 may be shorter than the duration CP strobe 501, and control strobe 503 may start with the beginning of the CP strobe (shown as 506). In other words, strobe signal 507 is generated by, or at, the receiver as an indication of the time during which control signals may be applied, for adjusting respective parameters, without interfering with the data or information reception. Strobe signal 507 may be generated by the receiver's demodulator or by any suitable circuit element or unit capable of identifying CPs time instants and duration.

Assuming that the impulse response of the system between the transmitter's output and the input of the fast Fourier transform (“FFT”) engine in the demodulator (for example ADC and Demodulator 102 in FIG. 1), which is normally the place where the received extended symbols are evaluated, is shorter than the guard interval period (the guard interval is chosen to meet the latter condition), then any resulting transient signal interfering with the received signal for a fraction of time will terminate within the CP period (502 or 503) and, therefore, it will not affect the decoded data in a detrimental manner. Therefore, every tuner control strobe (for example control strobe 503) rises with the beginning of the corresponding cyclic prefix and falls at the latest after a time period that equals the cyclic prefix duration (for example duration 501) minus the “tuner-to-FFT impulse response” duration (shown at 508). The longer the tuner-to-FFT impulse response period, the shorter the maximum duration of the control strobe because the total CP duration has to accommodate both settlement of new parameters and transient phenomena resulting from the new parameters settled.

The cyclic prefix period 502 is usually known a priori, as being part of the modulation standard, or scheme, and the tuner-to-FFT impulse response duration 508 is also known to the telecommunication system designer, or it can be conveniently measured. Therefore, the time duration of the control strobe 503 may be conveniently found.

Having considered the tuner-to-FFT impulse response duration as described hereinbefore, adjustments made to receiver parameters (by applying corresponding control signals) during a tuner control strobe will have essentially no effect on the demodulator and the data decoding circuitry during reception of the data itself; that is, during the active symbol period. The demodulator and data decoder circuitry will essentially experience the adjusted signal(s) only after reaching their steady state.

Because transient phenomena have detrimental effect on the reception quality, it is clear that eliminating transients during active symbol periods may greatly improve the signal-to-noise ratio (“SNR”) characteristics of an OFDM-enabled receiver and, consequently, the bit error rate (“BER”) associated with the decoded data. It is noted that any type of OFDM-enabled apparatus may benefit from the principles disclosed herein.

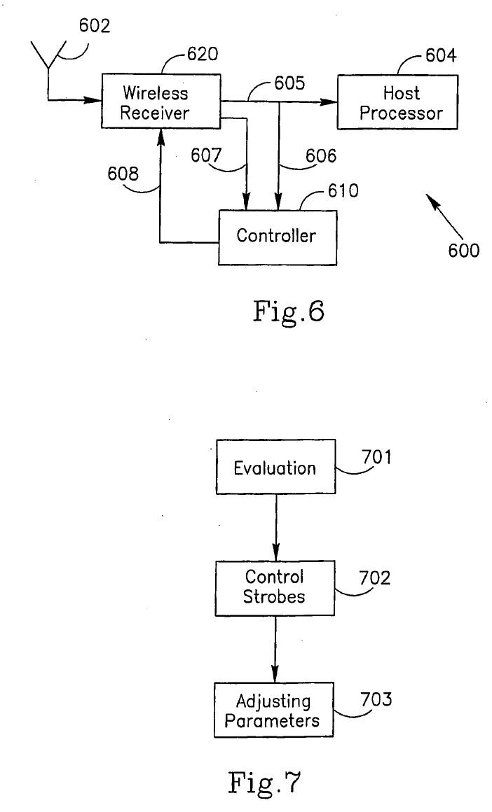

FIG. 6 schematically illustrates an exemplary receiving system according to some embodiments of the present disclosure and FIG. 7 shows an exemplary simplified block diagram of a method for adjusting a receiver according to some embodiments of the present disclosure. FIG. 6 will be described in association with FIG. 7.

OFDM-enabled receiving system 600 may include Wireless Receiver 620 that functions in a way similar to Wireless Receiver 120 of FIG. 1, Host Processor 604 that functions in a way similar to Host Processor 104 of FIG. 1, and Controller 610. Controller 610 may be adapted to evaluate the reception quality of each received extended symbol (shown as step 701 in FIG. 7), which is/was currently/previously received at antenna 602 and processed by Wireless Receiver 620, by monitoring (by Controller 610) signals that are related to, or associated with, received extended symbol(s). By “monitoring” is meant monitoring signals that Wireless Receiver 620 may forward (shown at 605) to Host Processor 604 (the monitoring being shown at 606), or monitoring signals within Wireless Receiver 620 (the monitoring being symbolically shown at 607), as they are internally processed by Wireless Receiver 620, or both.

According to some embodiments of the present disclosure Wireless Receiver 620 may be adapted to detect, in a received stream of extended symbols, the temporal location and duration of each cyclic prefix, and to forward to Controller 610 (shown at 607) a CP strobe signal that may look like CP strobe signal 505 of FIG. 5, though only one CP strobe is shown in FIG. 5 (shown at 501), for FIG. 5 shows only one extended symbol (shown as 500). According to some other embodiments of the present disclosure Controller 610 may be adapted to detect, in a received stream of extended symbols, the temporal location and duration of each cyclic prefix and to generate therefrom the CP signal.

Controller 610 may be also adapted to generate from the CP strobe signal a control strobe signal (shown as step 702 in FIG. 7), which may look like control strobe signal 507 of FIG. 5, though only one control strobe is shown in FIG. 5 (shown at 503), for FIG. 5 shows only one CP strobe (shown at 501). In accordance with the principles disclosed by the present disclosure, Controller 610 may be adapted to generate control strobes such that each control strobe preferably starts with the beginning of the respective CP strobe and has a duration that is preferably shorter than the duration of the respective CP strobe, for accommodating the tuner-to-FFT impulse response time of Wireless Receiver 620.

After Controller 610 evaluates the reception quality, and, in general, the performance of Wireless Receiver 620, Control 610 may change, or adjust, one or more parameters of Wireless Receiver 620 (shown as step 703 in FIG. 7) by applying corresponding control signals (shown at 608) to Wireless Receiver 620 during a control strobe. Controller 610 may be further adapted to apply control signals to Wireless Receiver 620 during every control strobe, before receiving the next extended symbol, or after receiving a predetermined number of symbols, or whenever desired or required; that is, whenever the reception quality deteriorates to a prescribed quality level.

While certain features of the disclosure have been illustrated and described herein, many modifications, substitutions, changes, and equivalents will now occur to those skilled in the art. It is, therefore, to be understood that the appended claims are intended to cover all such modifications and changes as fall within the true spirit of the disclosure.

What is claimed is:

1. A method of adjusting one or more parameters of a receiver, comprising:
a) generating one or more control signals associated with said one or more parameters; and
b) applying said one or more control signals to said receiver during a cyclic prefix period to adjust said one or more parameters.

2. The method according to claim 1, wherein the receiver generates control strobes in synchronization with respective cyclic prefix periods wherein each of said control strobes essentially begins with the respective cyclic prefix and has a duration shorter than the duration of said cyclic prefix period.

3. The method according to claim 2, wherein the duration of the control strobe is chosen such that substantially each one of the one or more parameters, after applying corresponding control signals, reaches its steady state before the cyclic prefix period lapses.

4. The method according to claim 1, wherein the parameters are selected from a group of parameters consisting of {The gain of the low-noise-amplifier G_{LNA}; The synthesizer's local frequency F_{LO}; The DC correction level L_{DC}; The power amplifier gain G_{PGA}; I/Q error, The mixer's gain G_{MIX}}.

5. The method according to claim 1, wherein one or more control signals are generated by the demodulator of the receiver.

6. The method according to claim 1, wherein one or more control signals are generated externally to the receiver.

7. The method according to claim 1, wherein one or more control signals are determined according to previously received extended symbols.

8. The method according to claim 1, wherein one or more of the control signals is determined according to a currently received extended symbol.

9. The method according to claim 1, wherein a control signal is applied to the receiver during each control strobe.

10. The method according to claim 1, wherein a control signal is applied to the receiver after receiving a predetermined number of extended symbols and during a corresponding control strobe.

11. The method according to claim 1, wherein a control signal is applied to the receiver whenever required and during a corresponding control strobe.

12. A wireless receiving system, comprising:
a wireless receiver adapted to receive a stream of extended symbols; and
a controller adapted to monitor and evaluate the performance of said wireless receiver, generate control strobes in synchronization with respective cyclic prefixes contained within a received stream of extended symbols, and to generate and apply to said receiver one or more control signals during a control strobe for adjusting one or more parameters of said receiver,
wherein each of said control strobes essentially begins with the respective cyclic prefix and has a duration shorter than the duration of said cyclic prefix period.

13. The receiving system according to claim 12, wherein the duration of the control strobe is chosen such that substantially each one of the one or more parameters, after applying corresponding control signals, reaches its steady state before the cyclic prefix period lapses.

14. The receiving system according to claim 12, wherein the parameters are selected from a group of parameters consisting of {The gain G_{LNA} of the low-noise-amplifier; The synthesizer's local frequency F_{LO}; The DC correction level L_{DC}; The power gain amplifier G_{PGA}; I/Q error, The gain of the mixer G_{MIX}}.

15. The receiving system according to claim 12, wherein one or more control signals are generated by a demodulator of the receiver.

16. The receiving system according to claim 12, wherein one or more control signals are generated externally to the receiver.

17. The receiving system according to claim 12, wherein one or more control signals are determined according to previously received extended symbols.

18. The receiving system according to claim 12, wherein one or more of the control signals is determined according to a currently received extended symbol.

19. The receiving system according to claim 12, wherein a control signal is applied to the receiver during each control strobe.

20. The receiving system according to claim 12, wherein a control signal is applied to the receiver after receiving a predetermined number of extended symbols and during a corresponding control strobe.

21. The receiving system according to claim 12, wherein a control signal is applied to the receiver whenever required and during a corresponding control strobe.

22. A wireless receiver, comprising:
a controller adapted to receive a stream of extended symbols, monitor and evaluate the performance of said receiver, generate control strobes in synchronization with respective cyclic prefixes contained within received extended symbols, and to generate and apply to said receiver one or more control signals during a control strobe for adjusting one or more parameters of said receiver,
wherein each of said control strobes essentially begins with the respective cyclic prefix and has a duration shorter than the duration of said cyclic prefix period.

23. The receiver according to claim 22, wherein the duration of the control strobe is chosen such that substantially each one of the one or more parameters, after applying corresponding control signals, reaches its steady state before the cyclic prefix period lapses.

24. The receiver according to claim 22, wherein the parameters are selected from a group of parameters consisting of {The gain G_{LNA} of the low-noise-amplifier; The synthesizer's local frequency F_{LO}; The DC correction level L_{DC}; The power gain amplifier G_{PGA}; I/Q error, The gain of the mixer G_{MIX}}.

25. The receiver according to claim 22, wherein one or more control signals are generated by a demodulator of the receiver.

26. The receiver according to claim 22, wherein one or more control signals are generated externally to the receiver.

27. The receiver according to claim 22, wherein one or more control signals are determined according to previously received extended symbols.

28. The receiver according to claim 22, wherein one or more of the control signals is determined according to a currently received extended symbol.

29. The receiver according to claim 22, wherein a control signal is applied to the receiver during each control strobe.

30. The receiver according to claim 22, wherein a control signal is applied to the receiver after receiving a predetermined number of extended symbols and during a corresponding control strobe.

31. The receiver according to claim 22, wherein a control signal is applied to the receiver whenever required and during a corresponding control strobe.
